(19) United States
(12) Patent Application Publication
(10) Pub. No.: US 2007/0044137 A1
(43) Pub. Date: Feb. 22, 2007

(54) Audio-video systems supporting merged audio streams

(76) Inventor: James D. Bennett, San Clemente, CA (US)

Correspondence Address: GARLICK HARRISON & MARKISON, P.O. BOX 160727, AUSTIN, TX, 78716-0727, US

(21) Appl. No.: 11/208,915

(22) Filed: Aug. 22, 2005

(51) Int. Cl. H04N 7/16; H04N 11/00; H04N 7/00; H04N 7/173

(52) U.S. Cl. 725/141; 348/552; 725/133; 725/153

(57) ABSTRACT

An audio/video processing system combines a locally generated audio signal with pre-recorded audio/video programming to produce combined audio/video output. The audio/video system allows users to generate sound locally, mix them with the audio content of a pre-recorded audio/video program, and allows combined output to be presented by home audio/video system video displays and the speakers. The audio/video system provides independent sound characteristic control capability, such as volume control settings and voice and tone alterations settings and the equalization settings, for the various sound components produced in the process of mixing locally generated sounds. The sound components produced in the process of mixing include locally generated sound components, such as the voice sound component, the musical instrument sound components, and the sound components of the pre-recorded audio program such as voice, musical instrument and the background sound components. The pre-recorded audio/video programs may be obtained on the pay-per-view basis.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention generally relates to audio-video systems.

2. Related Art

Audio/video (AV) systems are in wide spread use and typically include a video display and a corresponding sound system. Audio/video sources for such systems include Set-Top-Boxes (STBs), Digital Video Disk (DVD) players, Personal Video Recorders (PVRs), and computers, among other sources. The audio/video sources provide a wide variety of programming, both live and pre-recorded, that may be presented using the audio/video system.

For entertainment purpose, users often participate during the presentation of programming. For example, users may sing along with movie sound tracks, music videos, and other programming. With conventional programming, the user simply joins in with the presented programming.

Karaoke, on the other hand, is a type of entertainment with which a machine plays the music of a song and a user joins in by providing the vocals to the song. The Karaoke machine receives the vocals from the user, combines the vocals with the music, and presents the combined result to the user.

Learning to play an instrument often begins with listening to programming containing the desired instrument. Then, when the student progresses in learning to play the instrument, the user may play along with the programming. Unfortunately, it is often difficult to prevent the AV system and the instrument from drowning each the other out with excessive volume.

### BRIEF SUMMARY OF THE INVENTION

The present invention is directed to apparatus and methods of operation that are further described in the following Brief Description of the Drawings, the Detailed Description of the Invention, and the Claims. Features and advantages of the present invention will become apparent from the following detailed description of the invention made with reference to the accompanying drawings.

### BRIEF DESCRIPTION OF THE DRAWINGS

FIG. 1 is a block diagram illustrating a home A/V (Audio/Video) infrastructure that has an AVPS (Audio/Video Processing System) integrated therein to support merging of locally produced audio with that of a media program in accordance with the present invention;

FIG. 2 is a schematic block diagram illustrating the functional details of one embodiment of an AVPS component of FIG. 1, wherein the audio portion of a media program is combined with locally generated audio;

FIG. 3 is a schematic block diagram illustrating an embodiment of the circuitry of FIG. 2 that individually processes both the audio component of a media program and locally generated audio signals before combining them;

FIG. 4 is a block diagram illustrating an embodiment of the circuitry involved in combining the locally generated audio signals with audio from a media program, according to the present invention;

FIG. 5 is a block diagram illustrating the functional details of set-top-box that combines a locally generated audio signal with the audio signal of a pre-recorded audio/video program to produce combined audio/video output;

FIG. 6 is a flow diagram illustrating the method involved in receiving pre-recorded audio/video program content from a storage media and combining the audio content with locally generated audio signals, according to the present invention; and

FIG. 7 is a flow chart 705 illustrating the method used in downloading the pre-recorded audio/video program on a pay-per-view basis.

### DETAILED DESCRIPTION OF THE INVENTION

The present invention relates generally to home audio-video systems and the following description involves the application of the present invention to a home audio-video system. Although the following description relates in particular to the application of the present invention to a home audio-video system, it should be clear that the teachings of the present invention might be applied to other types of audio-video systems and to audio systems alone.

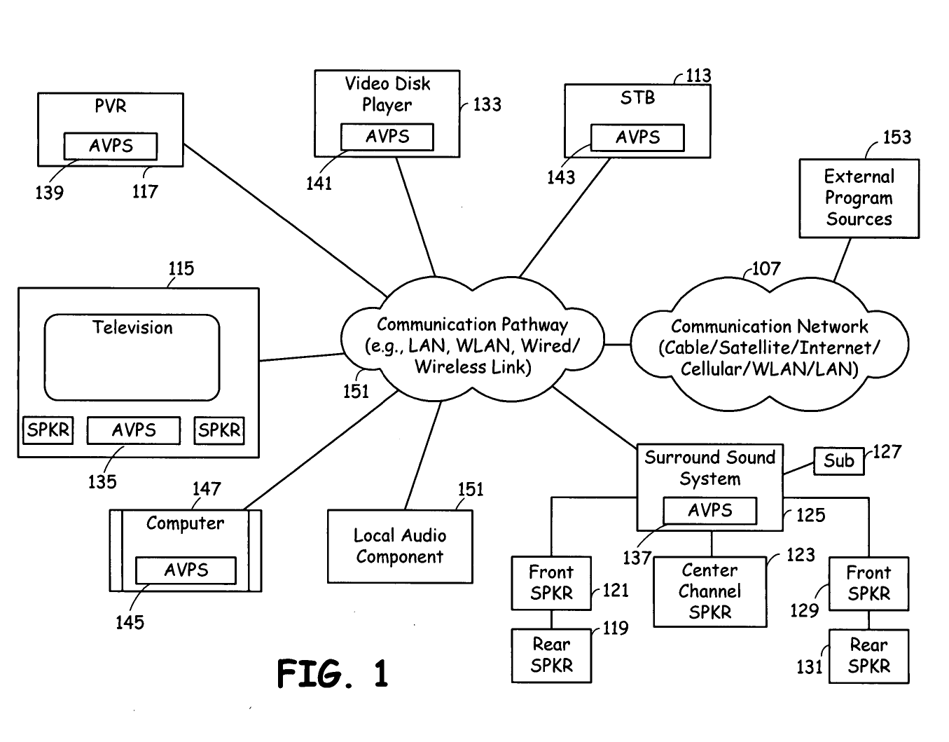

FIG. 1 is a block diagram illustrating a home A/V (audio/video) infrastructure that has an AVPS (Audio/Video Processing System) integrated therein to support merging of locally produced audio with that of a media program in accordance with the present invention. A local audio component 151, such any one or more of a musical instrument, microphone pick-up placed on or near an instrument, and microphone capturing human voice, produces a locally generated audio signal that is delivered to an AVPS component located within a piece of media equipment. The media equipment merges the locally generated audio signal with the audio portion of a media program prior to presentation to a viewing listener on a speaker system. The media program, such as a music video, movie or movie segment, live concert broadcast, etc., consists of a video portion and an audio portion that together are typically captured, associated, stored, and communicated pursuant to one or more industry or proprietary standards. Herein, the terms “A/V”, “audio/video” and “media” are synonymous and may be used interchangeably.

More specifically, in a media infrastructure 105, AVPS components 135, 137, 139, 141, 143 and 145, are incorporated into various pieces of home media equipment, i.e., a television 115, surround sound system 125, PVR (Personal Video Recorder) 117, video disk player 133, STB (Set-Top-Box) 113 and computer 147, respectively. Although not shown, other types of home media equipment such as game units or consoles might also receive AVPS components.

The media equipment 115, 125, 117, 133, 113, and 147 communicatively inter couples via a communication pathway 151. The communication pathway 151 may consist of any one or combination of local area networks (LANs), wireless local area networks (WLANs) and wired and wireless point-to-point links.

External media program sources 153 represent cable, satellite and fiber televisions channel broadcast service providers, Internet server based media program delivery systems, single channel television broadcasters, etc. Some of the external media program sources 153 directly deliver media programs to each piece of the media equipment 113, 133, 117, 115, 147, and 125 via a communication network 107. Some of the external media program sources 153 may also or alternatively deliver the media programs to one piece of the media equipment, which, in turn, forwards the delivery to the others. For example, a cable television service provider delivers multiple channel television broadcasts to the STB 113 via the communication network 107, and, in turn, the STB 113 delivers a viewer-selected one of the channels to the television 115 via the communication pathway 151. The communication network 107 includes cable, satellite, cellular, Internet, fiber and any other wired and wireless links or backbone networks (or combinations thereof) that may be needed to support the external media program sources 153.

Although each of the AVPS components 135, 137, 139, 141, 143 and 145 contain full AVPS processing functionality, such functionality might also be distributed in portions across two or more of the components 135, 137, 139, 141, 143 and 145. The AVPS may also include a separate piece of equipment (not shown) that provides dedicated AVPS functionality in addition to or as a replacement for some or all of the AVPS components 135, 137, 139, 141, 143 and 145. That is, the AVPS components 135, 137, 139, 141, 143, and 145 are either integrated into home A/V equipment with the rest of the functional circuitry of the home A/V equipment as illustrated, or housed independently. When housed independently, the AVPS component processes the media program either before: a) the media program reaches the home A/V equipment; b) the audio portion of the media program reaches the surround sound system 125; or c) the audio portion of the media program reaches the speakers 119, 121, 123, 129 and 131. In a situation where multiple AVPS components exists in home A/V equipment along a single signal path, such as AVPS components 141 and 133 existing in both the video disk player 133 and the television 115, one of the AVPS components 141 or 135 may be disabled, both can perform a portion of the AVPS functionality, or both might operate independently using two different locally generated audio signals. For example, because the television 115 and video disk player 133 both contain AVPS components, the user may select the AVPS component 141 to perform all AVPS functionality and disable the AVPS component 135. This selection process might also function automatically and without user input based on predefined settings.

The AVPS components 135, 137, 139, 141, 143 and 145 each operate by combining a locally generated audio signal with a media program to produce a combined A/V output. The combined A/V output is thereafter presented to users through various video screens and speakers. Media programs include those programs, either specifically designed for the purpose of the AVPS or conventional media programs that were produced without considering AVPS functionality. The media programs are received from the external program sources 153 or retrieved from an A/V disk (e.g., DVD), storage on the computer 147, storage on the PVR 117, or any other local storage. The media programs specifically designed for the AVPS components 135, 137, 139, 141, 143, and 145 may lack at least one audio sound component, such as a voice or instrument signal, and may be made available to the users on a paid or pay-per-view basis. A Karaoke on demand media program is an example of a media program that has been prepared with AVPS functionality in mind. A Karaoke media program will have the lead vocals removed and add Karaoke captioning. Specific instrument play-along media programs may be similarly constructed with captioning added that corresponds to musical notes to be played by a local (located at home) musical instrument.

In some embodiments, the user needs a “permit” to use fully paid or pay-per-view media programs. The payment for the use of a media program may be enforced through a service provider's internal infrastructure, e.g., Internet based authorization and billing procedures. Once payment has been verified, access to a program source database and/or playback authorization is enabled. The user may also purchase pre-recorded media programs on DVD or other storage, and automatically obtain use permissions for an unlimited or limited number of times. Other means of enforcing payment and obtaining permit are also contemplated. For media programs not specifically constructed for APVS functionality, e.g., a movie, a television program, an audio music/dialogue track, etc., additional payment to use with the present invention may be collected but is not required.

The media program sources for each of the AVPS components 135, 137, 139, 141, 143, and 145 include the external program sources 153, STB 113, videodisk player 133, PVR 117 and the computer 147. The videodisk player 133 and PVR 117 deliver AVPS processed media programs retrieved from unprocessed media programs stored locally. The media programs may be supplied by the external program sources 153 directly to media equipment having an AVPS component or indirectly via another piece of media equipment, such as the STB 113. The STB 113 receives media programs via the communication infrastructure 107, that is, any one or more of the cable, satellite, Internet, cellular, WLAN and LAN. Media programs may also be retrieved from another location accessible via the communication pathway 151 and communication network 107, such as from Internet based remote servers of the external program sources 153.

Each of the AVPS components process the audio portion of a media program, and combine therewith at least one locally generated audio signal prior to presentation to a user. With separate and relative adjustments for volume, equalization, surround sound and other special effects (hereinafter “independent audio adjustments”) applied to the media program audio portion and the locally generated audio, a listener can control the overall, combined sound output. Media programs specifically designed for such use include music videos that have been recorded without lead and/or background vocals, guitars, drums or other musical instruments included. The locally generated audio would then be used as a replacement.

For media programs that have been recorded without removing a particular component, each of the AVPS components are capable of removing or at least attenuating a portion of the underlying sound components. Such removal occurs pursuant to a user request. For example, after receiving a music video from one of the external program sources 153 and pursuant to a user's selection, the AVPS component 143 removes or attenuates audio signals corresponding to keyboard music from the media program audio, and combines the remainder with locally generated keyboard music from the local audio component 151. The AVPS components 135, 137, 139, 141, 143 and 145 each combine processed audio signals with the video signals to form a combined media program that is presented via home media equipment displays and speakers.

Each of the AVPS components process locally generated audio signals received from the local audio component 151 before combining it with the audio of the media program. Exemplary types of independent audio adjustments of the locally generated audio signal include volume control, equalization settings, voice and tone alteration settings, surround sound, reverberation and other special effects. The AVPS components similarly but independently process the audio signals of the media program. All of such adjustments can be modified or turned off by the user. The adjusted, locally generated signal and the adjusted, audio signal of media program are thereafter combined to form a combined audio signal. The combined audio signal is presented to the user in the combined format and/or stored on the PVR 139, computer 147 or other local or remote device for later playback.

The routing of the combined audio signal for presentation or storage may require a further combination of the combined audio signal with the video portion of the media program. Alternatively, the routing of the combined audio and video portion might flow independently without requiring combination to one or more of the television 115, surround sound system 125, computer 147, or different destinations for storage and/or presentation.

The surround sound system 125 typically consists of a set of speakers with well-coordinated sound signal input. For example, to support a DVD 5.1 audio standard, the surround system 125 delivers audio signals to: a) a sub woofer 127 usually placed in the front of the hall; b) a center channel speaker 123 placed in the front-center of the hall; c) two front speakers 121 and 129 placed in the front-left and front-right of the hall; and d) two rear speakers 119, 131 placed in the rear-left and rear-right of the hall. The surround sound system 125 may also provide audio signals to the television 115. As a default, the combined audio is presented via the surround sound system 125 and the speakers 119, 121, 123, 129 and 131. As an alternative, the user may select separate presentation of the locally generated audio and the media program audio. If selected, the surround sound system 125 presents the locally generated audio via the center channel speaker 123 and the media program audio via the front and rear speakers 119, 121, 129, and 131. The user may also select and switch between: a) turning off the locally generated audio or the media program audio; b) turning off the media program audio; c) turning off or modifying the intensity or extent of the media program audio component extraction; and d) turning off the AVPS functionality.

In one operation of the present invention, the external program sources 153 may comprise an Internet based Karaoke on demand service with a database of media programs (not shown) available. The database of the media programs are displayed on a web browser of the computer 147 (or any other of the media equipment supporting such operation) allowing the user to choose from a list of the media programs. The media program lists may contain music video, movie clips or television program clips, for example. The user downloads these media programs on pay-per-view basis, that is, by authenticating in the web browser and obtaining permit for limited number of uses of a media program. The user may store the downloaded media program in a memory such as a computer storage unit or an optical disk. The user pays for the use of media program via an electronic means or any other means. The details of permit such as title, owner's detail, and the number of allowed uses are encoded in the header of a pre-recorded or live broadcast media program. The AVPS components 135, 137, 139, 141, 143 and 145 in the home media equipment 113, 115, 117, 125, 133 and 147 have built-in circuitry and software that together recognize the codes of the permit and allow the user to combine the locally generated voice signal with the media program received from the program seller. The locally generated audio signal may be the voice of the user singing in conjunction with the background sound (music) and video of the media program. A Karaoke music media program may have embedded titles, musical notes, and lyrics that are to be displayed along with the other video and in synchrony with the underlying music being played.

In another operation, a user purchases Karaoke music media programs that have been pre-recorded on an optical disk or other removable or fixed storage. The purchase itself may provide authorization for an unlimited or pre-designated number of uses with the AVPS of the present invention. In such cases, the authorization may be encoded in the optical disk itself. The user may play back the purchased optical disk on the videodisk player 133 with video presentation via the television 115 and audio presentation via the surround sound system 125. Although any of the AVPS components 133, 115 and 125 could perform the AVPS functionality, the AVPS component 141 performs the operations on the received the Karaoke music media program and the locally generated audio received from the local audio source 151. The local audio source 151 in this example might be a wired or wireless microphone through which a user sings-along with the Karaoke media program video. The wireless microphone voice signal and its tone may be altered by the user through the independent audio adjustments provided in the AVPS component 141.

Alternatively, if the optical music video disk contains audio without the sound of a certain musical instrument, the user is able to generate that musical instrument sound locally. The musical instruments may include an electronic synthesizer, a string instrument with electronic output and/or a percussion instrument coupled to the AVPS via a microphone. This kind of a situation arises while learning to use a particular musical instrument, for example. Similarly, the AVPS components 135, 137, 139, 141, 143, and 145 may be used in many other situations that involve learning as well as entertainment. Many other alternative methods of obtaining payment (or pay-per-view) for AVPS supported media programs and other applications of the invention are contemplated.

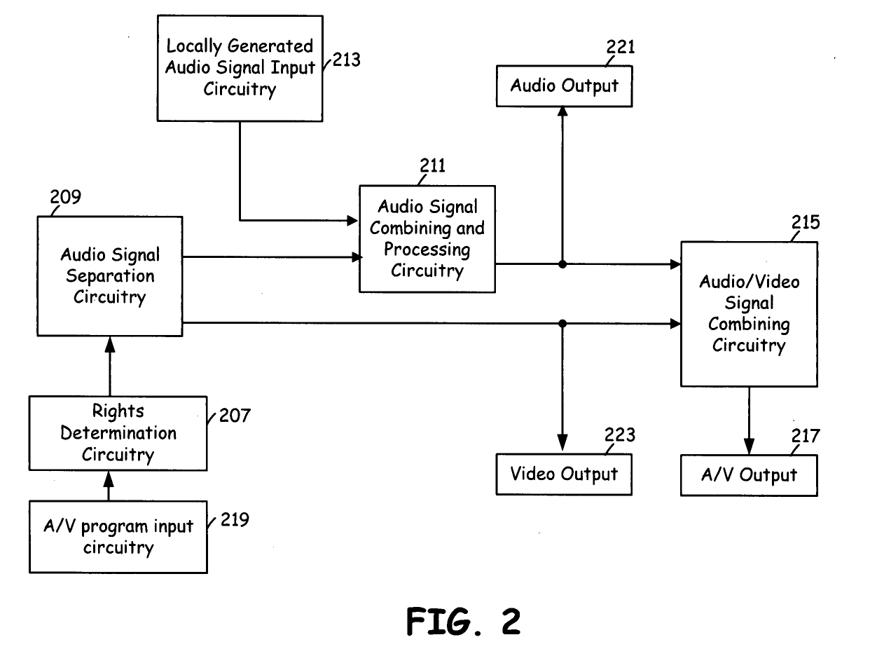

FIG. 2 is a schematic block diagram illustrating the functional details of one embodiment of an AVPS component of FIG. 1, wherein the audio portion of a media program is combined with locally generated audio. The circuitry of the AVPS component 205 comprises an audio signal separation circuitry 209, a rights determination circuitry 207, an A/V program input circuitry 219, a locally generated audio signal input circuitry 213, an audio signal combining and a processing circuitry 211, an A/V signal combining circuitry 215 and an A/V output 217.

In general, the AVPS component 205 receives the media program and locally generated audio, independently processes then combines audio signals of the media program and the locally generated audio signals to produce a processed and combined A/V output. The A/V program input circuitry 219 receives the media program from any local or external source, e.g., the STB 113, videodisk player 133, PVR 139, television 115, surround sound system 125, the computer 147, or external program sources 153. The media program is received in an analog or digital stream or file that is constructed pursuant to one or more proprietary formats and industry standards, such as a MPEG (Moving Picture Experts Group), NTSC (National Television Systems Committee), PAL (Phase Alternation Line), VGA (Video Graphics Array), QVGA (Quadrature Video Graphics Array) and HDTV (High Definition TeleVision). If the media program is received in an analog form, an A/D converter within the A/V program input circuitry 219 converts the audio to a digital form.

The rights determination circuitry 207 determines whether a user has rights to produce the combined A/V output. When the user does have rights to produce the combined A/V output, the rights determination circuitry 207 allows the user to combine the locally generated audio signal with the audio content. Further, the user may have a permit for the use of the media program only for a limited number of times. In this case, the rights determination circuitry 207 keeps track of number of times the media program is being used and does not allow any further use of the program. For determining the rights of the user, each digital media program file and stream comes with a header containing information such as the title of the media program, the owners of the media program and the user rights. Analog media program streams handle user rights out of band. When the user does not have any rights to employ the AVPS component 205, the rights determination circuitry 207 prevents such further use by not delivering the media program to the audio signal separation circuitry 209.

The audio signal separation circuitry 209 receives the media program if the user has the permit, as determined by the rights determination circuitry 207. If the media program is encrypted or compressed, the A/V separation circuitry first performs decryption or decompression before segregating the media program into an audio portion and a video portion. The audio signal separation circuitry 209 delivers the segregated digital audio to the audio signal combining and processing circuitry 211. The audio signal separation circuitry delivers the digital video to the A/V signal combining circuitry 215, and performs and needed encryption or compression on the digital video before delivery to a video output 223. If needed, the video output 223 performs digital to analog conversion before delivering the video to any home media equipment that might be storing or presenting only the video portion of the program.

The locally generated audio signal input circuitry 213 receives one or more audio signals from local sources such as wired or a wireless microphones (not shown) or a signals from musical instruments (not shown). The analog signals received from the microphone or the musical instruments are digitized by the locally generated audio signal input circuitry 213 and sent to the audio signal combining and processing circuitry 211 for further processing.

The audio signal combining and processing circuitry 211 receives one or more of the audio signals from the locally generated audio signal input circuitry 213 as well as the audio content of media program from the audio signal separation circuitry 209. The audio signal combining and processing circuitry 211 processes each of the audio input signal received individually. The processing of the locally generated signals includes gain control, special effects processing, equalization, and voice sound and tone alteration. If not already done in the media program, before processing the audio content of the media program, the audio signal combining and processing circuitry 211 removes at least one voice content or at least one musical instrument, according to user predefined or on-the-fly selections. The audio signal combining and processing circuitry 211 also processes the audio content of the media program, the processing itself include gain control, special effects processing, equalization and voice and tone alterations. The programming set-up for all of the above mentioned controls for the individual processing locally generated signals and audio signals of the pre-recorded media program are provided to the user in the form of buttons on the home media equipment 113, 133, 117, 115, 147 and 125 (FIG. 1) or via a remote control (not shown). The processed signals are then combined to form a processed and combined audio signal that is channeled to the A/V combining circuitry 215 and the audio output 221. If encryption and compression are needed, the audio signal combining and processing circuitry 211 will do so before channeling the combined audio output.

The A/V signal combining circuitry 215 receives the video signals from the audio signal separation circuitry 209 and the combined audio signals from the audio signal combining and processing circuitry 211, and combines these signals into a composite media program before delivering the media program to the A/V output 217. The A/V output 217 forwards the delivery to any home media equipment that might be storing or presenting only the composite media program. Before forwarding, if needed, the A/V output 217 will perform digital to analog conversion.

Thus, to meet the needs of particular home entertainment system installation and user selection, the AVPS component 205 is able to separately output original video and combined audio as well as an overall combination of the combined audio and original video as may be needed or desired. For example, in the same home entertainment system, a television might be connected to A/V output 217, a surround sound system might be connected to the audio output 221, and an HDTV screen might be attached to the video output 223, at the same time.

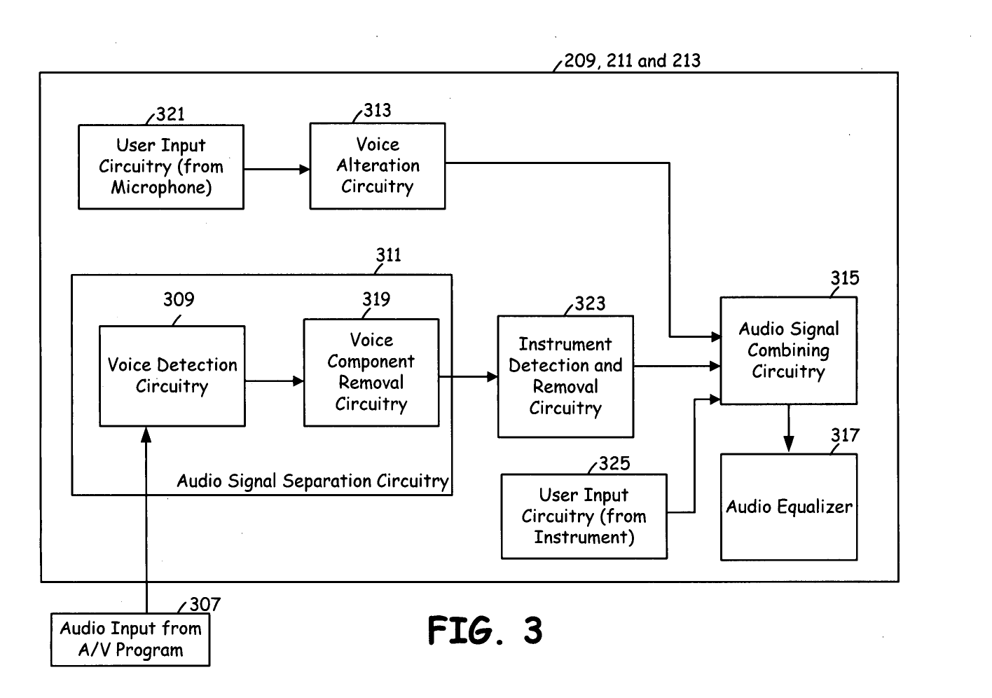

FIG. 3 is a schematic block diagram illustrating an embodiment of the circuitry of FIG. 2 that individually processes both the audio component of a media program and locally generated audio signals before combining them. In particular, such processing may be found in at least portions of the blocks 209, 211 and 213 (FIG. 2), and shows in detail the circuitry involved in processing and combining the audio signals of the media program and two locally generated audio signals. The circuitry 305 comprises an audio input from the media program 307, audio signal separation circuitry 311, instrument detection and removal circuitry 323, user input circuitry (from microphone) 321, voice alteration circuitry 313, user input circuitry (from instrument) 325, audio signal combining circuitry 315, and audio equalizer 317. The audio separation circuitry 311 further comprises of voice detection circuitry 309 and voice component removal circuitry 319.

The audio input from media program 307 receives audio content of the pre-recorded media program from one of the STB 113, videodisk player 133, PVR 139, television 115, surround sound system 125 and the computer 147. The audio signal for the audio input from media program 307 may also be received from the external program sources 153.

The voice detection circuitry 309 of the audio signal separation circuitry 311 detects voice signal in the incoming audio input signal. The voice detection circuit 309 employs digital signal processing means of auto correlation and cross correlation in order to detect and separate the voice signal from the background signal. Typical examples of voice detection circuitry 309 can be found in conventional cellular telephone circuitry and program code. The voice component removal circuitry 319 either completely removes at least one voice component of the audio input signal, or suppresses voice signal to a certain extent as programmed by the user. In case of the audio input signal from the pre-recorded media program not having any voice component, as may be the case with the Karaoke music video, the audio signal separation circuitry 311 simply allows the audio signal to pass through with out any alteration. The instrument detection and removal circuitry 323 identifies certain preprogrammed instrument sounds and either removes them completely or suppresses them to an extent set by the user. The user may switch both of the voice component removal circuitry 319 and the instrument detection and removal circuitry 323 off, if it is desired that these sounds not be removed. This is desirable as most of the pre-recorded media program may have at least one of voice signal or musical instrument signals removed.

The user input circuitry (from microphone) 321 receives locally generated analog voice signal from a wired or wireless microphone and digitizes the audio input signal before further processing it. The voice input may be that of a user singing along with a Karaoke music video, for example. The wireless microphone connected to the circuitry of 305 may use radio frequency means of Bluetooth. The processing of the locally generated audio input, by the user input circuitry 321, include volume settings, equalization settings, tone adjustments, and sound alteration settings. The voice alteration circuitry 313 receives processed audio signals from the user input circuitry 321 and alters or distorts the voice signal according to one of many preprogrammed settings. The user input circuitry 321 and the voice alteration circuitry 313 employ means of digital signal processing to process the voice signal.

The user input circuitry (from instrument) 325 receives analog audio signals from at least one instrument, digitizes and processes them. Although the processing of musical instrument sound may not be necessary, the user may be provided with options of setting volume, equalization, tone adjustments, and sound alteration.

The audio signal combining circuitry 315 receives processed audio signals from the voice alteration circuitry 313, the instrument detection and the removal circuitry 323 and the user input circuitry 325 and combines them to produce an audio output signal. An optional audio equalizer circuitry 317 provides equalization setting on the combined audio output signal.

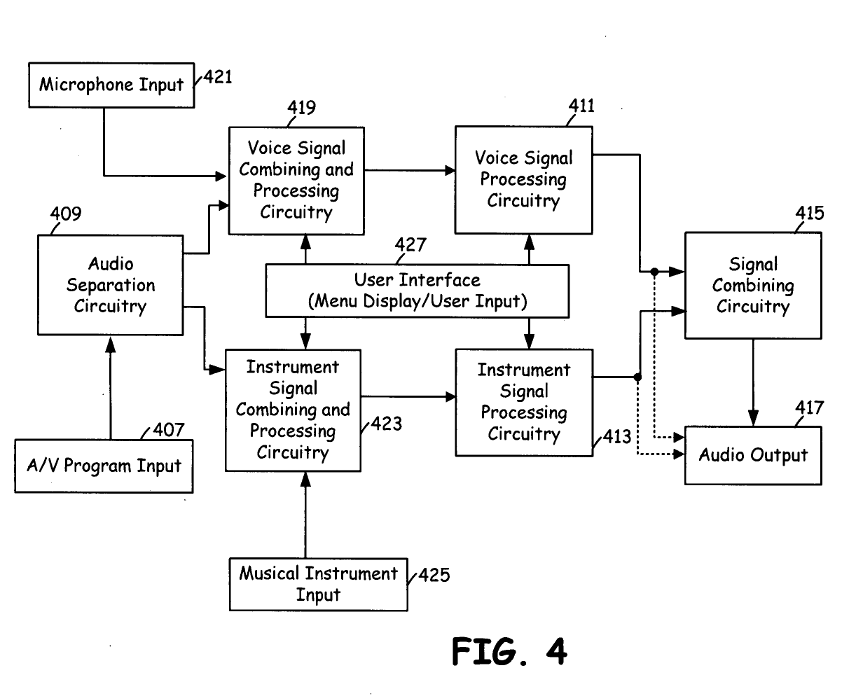

FIG. 4 is a block diagram illustrating an embodiment of the circuitry involved in combining the locally generated audio signals with audio from a media program, according to the present invention. The block diagram 405 shows another embodiment of the circuitry shown in FIG. 3, and specifically targets Karaoke on demand music video programs. It comprises of a microphone input 421, an media program input 407, a musical instrument input 425, an audio separation circuitry 409, a voice signal combining and processing circuitry 419, a instrument signal combining and processing circuitry 423, a voice signal processing circuitry 411, an instrument signal processing circuitry 413, a signal combining circuitry 415, an user interface 413 and an audio output 417.

The media program input 407 receives the audio portion of the pre-recorded media program from audio signal separation circuitry 209 (FIG. 2). The pre-recorded media program input 407 may come from any one of the home A/V systems 113, 133, 117, 115, 147 and/or 125 or from the external program sources 153, as described with reference to FIG. 1. The microphone input 421 receives voice signal and the musical instrument input 425 receives sounds of musical instruments, from the user. Although the block diagram 405 in FIG. 4 shows a single microphone input and a single musical instrument input 425, provisions are provided for plurality of microphone and musical instrument inputs. The analog signals received by the microphone input 421 and the musical instrument input 425 are digitized by the respective input units 421, 425.

The audio separation circuitry 409 segregates the audio input signal into a voice signal and an instrument signal. The technique used in separation of audio input into the voice signal and the instrument signal may involve digital signal processing techniques of auto and cross correlations, or the techniques used in voice detection circuits. Many different voice detection techniques are commonly used by the cellular phone industry, for example.

The voice signal combining and processing circuitry 419 receives the voice content of the media program input 407 from the audio separation circuitry 409 and the digitized user voice signal from the microphone input 421. These two voice streams are independently processed by the voice signal combining and processing circuitry 419 for volume settings, voice and tone alteration settings. Then, the voice signal combining and processing circuitry 419 combines these two signals to produce one single voice output. The voice signal processing circuitry 411 further processes the voice signal input received from the voice signal combining and processing circuitry 419. The processing in voice signal processing circuitry 411 may include equalization settings and special effect settings. The special effect processing may involve deliberate distortions of voice signal, for example.

The instrument signal combining and processing circuitry 423 receives instrument content of the media program input 407 from the audio separation circuitry 409 and the digitized musical instrument signal from the musical instrument input 425. These two instrument signals are independently processed by the instrument signal combining and processing circuitry 423 for the volume settings and the tone alteration settings. Then, the instrument signal combining and processing circuitry 423 combines these two signals to produce one single instrument signal output. The instrument signal input received from the instrument signal combining and processing circuitry 423 is further processed by the instrument signal processing circuitry 413. The processing may include equalization settings and special effect settings.

The voice signal input from voice signal processing circuitry 411 and the instrument signal from the instrument signal processing circuitry 413 are combined to form a merged audio output signal and provided for presentation by audio output 417. Alternatively, the voice signals and the instrument signals may also be provided separately for presentation at audio output 417.

The user interface 427 provides a menu display and a user input control buttons to facilitate the user programming of the processing and combining in voice signal combining and processing circuitry 419, voice signal processing circuitry 411, instrument signal combining and processing circuitry 423 and instrument signal processing circuitry 413. The user input control buttons of user interface 427 allow user to select and control volume levels of each individual audio component including the voice signal from the microphone input 421, the voice signal from the audio separation circuitry 409, the instrument signal from the audio separation circuitry 409 and the instrument signal from the musical instrument input 425. For example, the user may set 0% volume for the voice component of the media program from the audio separation unit 409 and high volume level setting for the microphone input 421 if the user likes to sing for a music video. Alternatively, if the user likes to hear the voice of the music video program at low volume levels while singing, the user may keep the voice volume level of the input from the media program at 30% volume level. This may be the case when user is learning the art of singing.

Optional equalization selection and control buttons may be provided by the user input of the user interface 427, either individually on each of the audio input signals mentioned above or on the combined audio signals. The special effect user input buttons in user interface 427 provide many different special effects either on each individual above said input signal or on the combined voice and the combined instrument signals. Also, the user may be provided with control buttons to skip combining of certain audio components. For example, the musical instrument sound from the musical instrument input 425 may not be combined with the musical instrument sounds of a music video program from the audio separation circuitry 409 if the user is only interested in singing along.

The user interface 427 provided with the AVPS may include control buttons for all of the above mentioned combining and processing in the units 419, 423, 413 and 411 or may simply contain a smaller portion of them. For entertainment at home, however, the user may require only a smaller portion of the user input controls mentioned above. The display of the user interface 427 shows the user selections of buttons pressed as well as the levels of the volume settings, voice and tone alteration settings and equalizations, if any.

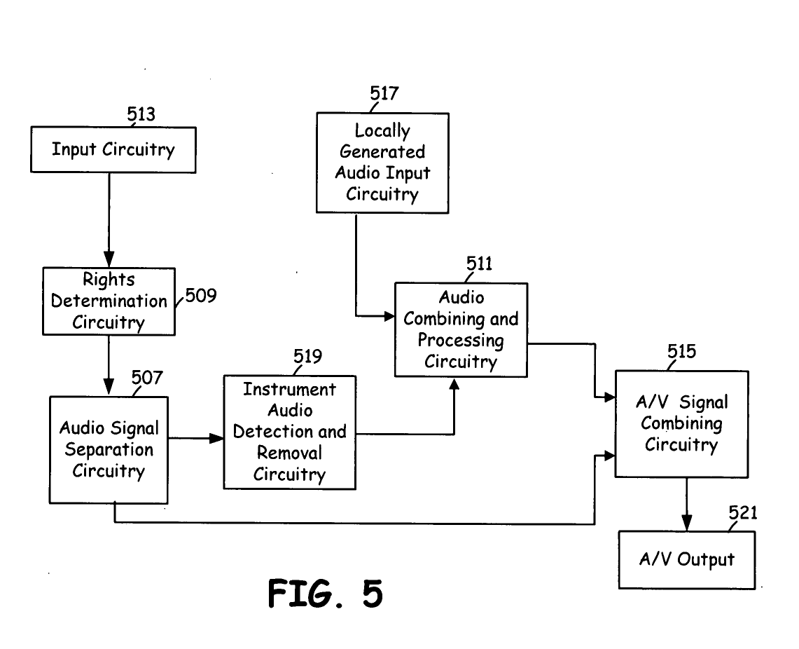

FIG. 5 is a block diagram 505 illustrating the functional details of set-top-box that combines a locally generated audio signal with the audio signal of a pre-recorded media program to produce combined A/V output. It comprises of an input circuitry 513, a rights determination circuitry 509, an audio signal separation circuitry 507, a instrument audio detection and removal circuitry 519, a locally generated audio input circuitry 517, an audio signal combining and processing circuitry 511, an A/V combining circuitry 515 and a A/V output 521.

The AVPS, as depicted in the FIG. 5, is most suitably integrated in to the set-top-box 113 since set-top-boxes are commonly used in conjunction with most of the home A/V systems and since most of the home A/V systems derive signals via a set-top-box. For example, the user may be able to use pre-recorded media program directly from the external program sources 153 shown in FIG. 1. The user may obtain permit to combine the locally generated audio signals with the audio content of the broadcast program via the external program sources 153 by subscribing to the corresponding program channel.

The set-top-box 113 receives either RF signals via the communication network 107 (FIG. 1) and dish antenna in case of the communication network being a satellite network, or a digital stream of pre-recorded media program via a cable or internet network, from the external program sources 153. The input circuitry 513 derives digital A/V signals of the pre-recorded media program from the radio frequency (RF) demodulator of the set-top-box, in case of the received signals being an RF carrier. The RF demodulator is typically a part of set-top-box that receives the pre-recorded media programs using RF carriers, but it is not a part of the AVPS, and is not shown in FIG. 5. In situations where the received A/V signals are digital streams, the input signal is directly received by the input circuitry 513.

The pre-recorded media program from the input circuitry 513 is sent to rights determination circuitry 509. The rights determination circuitry 509 deciphers the codes in the header of the pre-recorded A/V input signals and determines whether a user has rights to produce the combined A/V output. When the user does not have rights to produce the combined A/V output, the rights determination circuitry 509 prevents the user from combining the locally generated audio signal with the audio content of the pre-recorded media program. If, on the other hand, the user does have rights to produce the combined A/V output, the rights determination circuitry allows the combining of the locally generated audio signal with the audio content of the pre-recorded media program.

When the user does have the permission to combine the locally generated audio with the audio content, the rights determination circuitry 509 sends pre-recorded A/V signals to the audio separation circuitry 507. Here, the audio signal separation circuitry 507 separates the pre-recorded media programming into an audio content and a video content. The audio portion of the pre-recorded media program may not have voice content, if the program is of a Karaoke music video type.

The instrument audio detection and removal circuitry 519 detects and removes certain pre-programmed musical instrument audio from the audio content. The choice of the musical instrument sound to be detected and removed is made by the user. For example, if the user desires to sing along with a pre-recorded Karaoke music video while playing Guitar, the user may choose to remove Guitar sounds from the pre-recorded Karaoke music program.

The locally generated audio input circuitry 517 receives at least one locally generated sound, although the locally generated audio input circuitry is capable of receiving a plurality of input signals. These locally generated audio input signals are digitized by the locally generated audio input circuitry 517. These audio signals are separately sent to the audio signal combining and processing circuitry 511 for further processing.

The audio content of the pre-recorded media program from the audio signal separation circuitry 507 and the audio input streams from the locally generated audio input circuitry 517 are received by the audio signal combining and processing circuitry 511. These signals received by the audio signal combining and processing circuitry and individually processed for volume level settings, tone and voice alteration settings and the equalization. The control signals for the settings such as the individual volume levels of the audio input signals are provided by the user by a preprogrammed setting in a control memory (not shown) that resides in the audio combining and processing circuitry 511. Then, the individual input signals are combined to form a processed and combined audio signal.

Then, the processed and combined audio signal from the audio combining and processing circuitry 511 and the video content of the pre-recorded media program from the audio signal separation circuitry 507 are combined by the A/V signal combining circuitry and sent to A/V output 521. The A/V output may be provided via a port (for example, a USB port) to connect to the home A/V systems. Alternatively, the pre-existing set-top-box circuitries receive the A/V signals from the A/V output and may further process and deliver them to the home A/V systems.

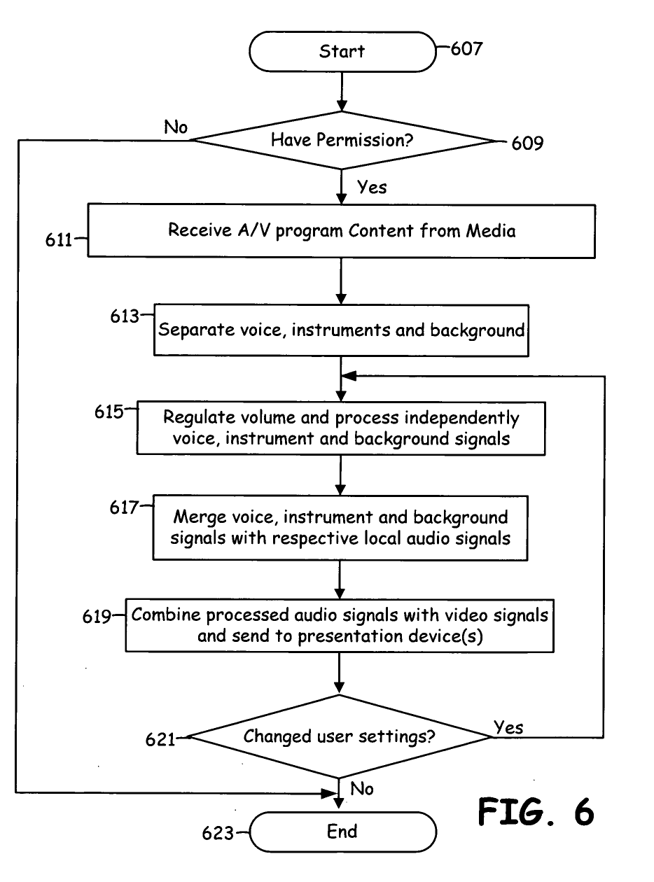

FIG. 6 is a flow diagram 605 illustrating the method involved in the AVPS receiving pre-recorded media program content from a storage media and combining the audio content with locally generated audio signals, according to the present invention. The method of A/V system receiving the pre-recorded media program from a storage media or a remote source and combining with the locally generated audio signals starts at block 607 with the system receiving the audio input from a storage media or a remote source.

Then, at the next block 609, a decision is taken regarding whether the user has the necessary permit to continue with the combining of the locally generated audio and if no, the entire process is stopped at block 623. If yes, the media program content is received from a media or a remote program source. The media may be any one of optical disk, computer memory or any other local or remote A/V storage media.

At block 613, the audio signal from the pre-recorded media program is separated and further, the voice contents, the instrument content and the background content (if any) are separated. Then, at the next block 615, the volume settings of the voice signals, the instrument signals and the background signals are separately controlled as per the user settings. Further, at block 615 these audio signal components of the pre-recorded audio/video program are independently processed for voice and/or tone alteration settings, equalization settings and special effects settings.

Then, at the next block 617, the voice contents, the instrument content and the background content of the pre-recorded media program are mixed with the respective processed locally generated audio signals. The processing of the locally generated audio signals contents may include the volume settings, the equalization settings, the voice and/or tone alteration settings and the special effects settings.

Then, at the block 619, the processed and combined audio signals are combined with the video contents of the pre-recorded media program to form a processed A/V signal. At the block 619, the processed and combined A/V signals are channeled to an output port for home A/V presentations. Alternatively, at block 619, the processed and combined A/V signals may be modulated in the set-top-box 113 (FIG. 1) and sent to a television for presentation.

Then, at the next decision block 621, the user program settings are checked with the control memory and a decision is taken about whether the user settings about the individual volume levels, the equalizations, the voice and tone alterations and the special effects are changed. If yes, the steps of blocks 615, 617 and 619 are repeated. If no, the combining process ends at block 623. This entire process of 605 is repeated until the pre-recorded A/V input ends.

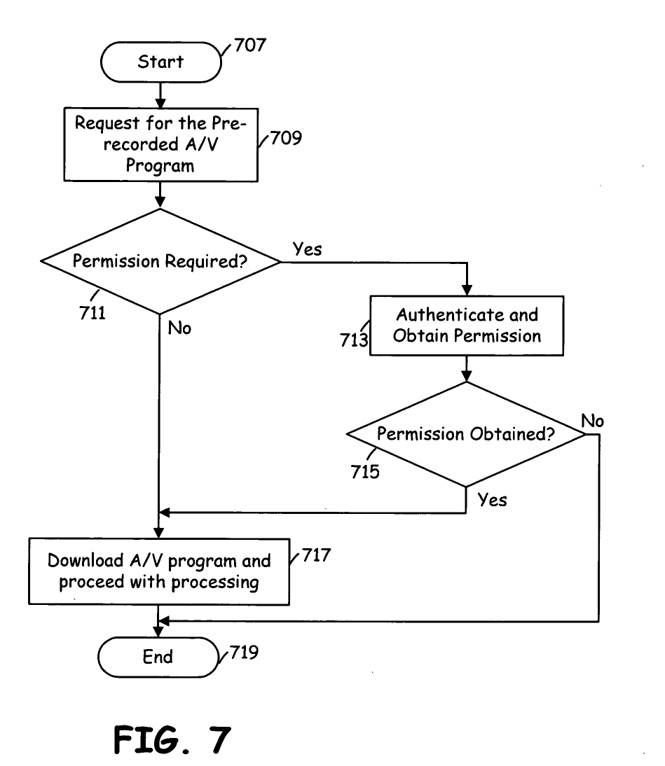

FIG. 7 is a flow chart 705 illustrating the method used in downloading the pre-recorded media program on a pay-per-view basis. The flow chart 705 shown in FIG. 7 is specifically intended to exemplify the process of downloading the pre-recorded media program from the Internet and use it to combine with the locally generated audio signals. The flow chart 705 shows a portion of the block diagram 605 (shown in FIG. 6) representing the permission required for the user to combine the locally generated audio signals.

The processes of obtaining the permitted pre-recorded media program starts at block 707. Then, at the next block 709, the user requests for a pre-recorded media program. For this, the user logs on to a website of choice in the Internet using a web browser and selects the desired programs from a list provided by the pre-recorded media program provider. Then, the user requests to download these programs by clicking with the mouse on the respective buttons.

Then, at the next decision block 711, the website decides whether there is a requirement of permission to the programs selected. If yes, at the next block 713, the user provides all the authentication and billing information, such as name, address and the paying methods, to the pre-recorded media program provider through the website pages. Although, from the perspective of the AVPS, all that is required is the permission encoded in the header, for the purpose of making payments for these user permits, the user needs to provide all the necessary information through the pre-recorded media program provider's website. If, at the block 711, it is decided that there is no need for permission to combine the pre-recorded media program with the locally generated audio contents, the process jumps to the next block 717.

Then, at the next decision block 715, a decision is taken regarding whether the user has obtained permission. If the user has not given all the necessary information for billing or does not make payment, the process of downloading ends at the block 719.

If at the decision block 715, user provides all the necessary information and makes payment, the user is allowed to download the pre-recorded media program and may proceed with combing them with locally generated audio signals. Then, the process of downloading ends at the block 719.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A media processing system that receives locally generated audio and a media program having associated program audio and program video, the media processing system comprising:
input circuitry that receives the media program and the locally generated audio;
separation circuitry that separates the program audio and program video;
processing circuitry that combines the locally generated audio and the program audio to produce modified audio; and
combining circuitry that combines the modified audio with the program video to produce a modified media program.

2. The media processing system of claim 1, wherein the separation circuitry removes a portion of the program audio.

3. The media processing system of claim 2, wherein the separation circuitry comprises voice detection circuitry that identifies the portion of the program audio by analyzing the program audio.

4. The media processing system of claim 2, wherein the separation circuitry comprises instrument detection circuitry that identifies the portion of the program audio by analyzing the program audio.

5. The media processing system of claim 1, further comprising rights determination circuitry that determines whether creation of the modified media program is authorized.

6. The media processing system of claim 1, further comprising equalization circuitry operable to equalize the combined audio signal based upon equalization input settings.

7. The audio/video processing system of claim 1 further comprising voice alteration circuitry operable to alter the vocal characteristics of the locally generated audio signal.

8. The audio/video processing system of claim 1, further comprising user input circuitry operable to receive input from a user and to produce volume settings, equalization settings, tone adjustments, and sound alteration settings based upon the input.

9. The audio/video processing system of claim 1, wherein the pre-recorded audio/video programming comprises Karaoke on demand programming.

10. The audio/video processing system of claim 1, wherein the pre-recorded audio/video programming comprises a music video.

11. The audio/video processing system of claim 1, wherein the pre-recorded audio/video programming comprises a movie.

12. A set top box that is operable to combine a locally generated audio signal with pre-recorded audio/video programming to produce combined audio/video output, comprising:
input circuitry operable to receive a signal from a remote source and to extract the pre-recorded audio/video programming from the signal;
audio signal separation circuitry operable to separate the pre-recorded audio/video programming into audio content and video content;
locally generated audio signal input circuitry operable to receive the locally generated audio signal;
audio signal combining and processing circuitry operable to combine the locally generated audio signal with the audio content to produce a combined audio signal; and
audio/video signal combining circuitry operable to combine the combined audio signal with the video content to produce the combined audio/video output.

13. The set top box of claim 12, wherein the audio signal separation circuitry is further operable to remove at least one voice component from the audio content.

14. The set top box of claim 12, further comprising instrument audio detection and removal circuitry that is operable to detect and remove musical instrument audio from the audio content.

15. The set top box of claim 12, further comprising rights determination circuitry operable to:
determine whether a user has rights to produce the combined audio/video output;
when the user does not have rights to produce the combined audio/video output, prevent the combining of the locally generated audio signal with the audio content; and
when the user does have rights to produce the combined audio/video output, allowing the combining of the locally generated audio signal with the audio content.

16. The audio/video system of claim 12, wherein the pre-recorded audio/video programming comprises Karaoke on demand programming.

17. A method for creating a merged audio stream from pre-recorded audio/video programming and locally generated audio, comprising:
verifying that rights exist to perform audio stream merging;
receiving audio/video programming;
segregating the an audio signal input into a voice signal, plurality of musical instrument signals and a background signal from a first pre-recorded audio/video program audio source;
regulating independently volume of voice, plurality of instrument and background signals of a first audio source and from a second locally generated source;
performing independent processing of voice, plurality of instrument and background signals on a first audio source and a second audio source; and
merging a second audio signal with a first audio signal.

18. The method of claim 17, wherein the step of verifying the permission further comprises:
receiving pre-recorded A/V program from a storage media or an external source;
authenticating and obtaining permission; and
allowing the Audio/video system to process and merge audio signals.

19. The method of claim 17, wherein the step of regulating independently volume further comprises:
regulating voice, instrument and background signals of a first audio source from a pre-recorded A/V program; and
regulating voice, instrument and background signals of a second locally generated audio source.

20. The method of claim 17, wherein the step of performing independent processing further comprises:
performing equalizations independently on voice, instrument, and background signals of a first audio source from a pre-recorded A/V program;
performing equalizations independently voice, instrument and background signals of a second locally generated audio source;
applying tone adjustment and voice alteration of voice signal of a second locally generated audio source; and
applying tone adjustment and musical instrument sound alteration of plurality of musical instrument signal inputs of a second locally generated audio source.

21. Set top box circuitry that receives locally generated audio and a media program having associated program audio and program video, the set top box circuitry comprising:
input circuitry that receives the media program and the locally generated audio;
separation circuitry that separates the program audio and program video; and
processing circuitry that combines the locally generated audio and the program audio to produce modified audio.

22. Television circuitry that receives locally generated audio and a media program having associated program audio and program video, the television circuitry comprising:
input circuitry that receives the media program and the locally generated audio;
separation circuitry that separates the program audio and program video; and
processing circuitry that combines the locally generated audio and the program audio to produce modified audio.

23. Stored media player circuitry used in home media equipment that receives locally generated audio and retrieves a stored media program having associated program audio and program video, the stored media player circuitry comprising:
input circuitry that receives the locally generated audio;
separation circuitry that separates the program audio and program video; and
processing circuitry that combines the locally generated audio and the program audio to produce modified audio.

24. In a home media installation that captures local audio and receives a media program having associated program audio and program video, surround sound circuitry comprising:
input circuitry that receives the captured local audio;
processing circuitry, communicatively coupled to the input circuitry, that combines the captured local audio and the program audio to produce combined audio; and
output circuitry that delivers the combined audio to a plurality of speakers.
